(19) United States
(12) Patent Application Publication
(10) Pub. No.: US 2024/0185550 A1
(43) Pub. Date: Jun. 6, 2024

(54) GENERATION OF EXPLODED VIEW OF GARMENT WITH SELECTED DISPLAYING OF GUIDE LINES CONNECTING SEWING LINES

(71) Applicant: CLO Virtual Fashion Inc., Seoul (KR)

(72) Inventors: Jae Hwan MA, Seoul (KR); Ho Hyun LEE, Seoul (KR); Hyung Gi HAM, Seoul (KR)

(21) Appl. No.: 18/444,047

(22) Filed: Feb. 16, 2024

Related U.S. Application Data
(63) Continuation of application No. PCT/KR2022/012303, filed on Aug. 17, 2022.

(30) Foreign Application Priority Data
Aug. 17, 2021 (KR) 10-2021-0107825
Nov. 26, 2021 (KR) 10-2021- 0165660
Aug. 17, 2022 (KR) 10-2022-0102699

(51) Int. Cl. G06T 19/20

(52) U.S. Cl. CPC G06T 19/20; G06T 2200/24; G06T 2210/16; G06T 2210/62; G06T 2219/016

(57) ABSTRACT

According to an example embodiment, a sewing simulation method in a three-dimensional (3D) exploded view includes: generating a 3D exploded view in which a distance increases between at least one piece included in a design article and a plurality of patterns included in the piece; displaying a plurality of sewing lines related to a selected piece determined based on an input of selecting one piece from among the at least one piece, based on sewing line matching information, wherein the sewing line matching information includes a matching relationship between sewing lines on outlines of different patterns; and displaying a plurality of sewing lines related to a selected pattern determined based on an input of selecting one pattern from among the plurality of patterns, based on the sewing line matching information.

### CROSS-REFERENCE TO RELATED APPLICATIONS

This is a bypass continuation-in-part application of International PCT Application No. PCT/KR2022/012303, filed on Aug. 17, 2022, which claims priority Republic of Korea Patent Application Nos. 10-2021-0107825, filed on Aug. 17, 2021, 10-2021-0165660, filed on Nov. 26, 2021, and 10-2022-0102699, filed on Aug. 17, 2022, which are incorporated by reference herein in their entirety.

### TECHNICAL FIELD

Embodiments relate to displaying and manipulating a 3D representation of a design article such as a garment.

### BACKGROUND ART

Garments appear in three dimensions when worn on a person's body, but they are made of two-dimensional fabric pieces cut according to a two-dimensional pattern. Because fabric is flexible, its appearance may vary according to a shape of the person wearing the garment or a motion of the person wearing the garment.

In a three-dimensional (3D) simulation, patterns of a garment piece may be joined by connecting sewing lines in the patterns. Such sewing lines may be selected and modified by a user when the design of the garment piece is being modified. The displaying of numerous sewing lines on a display device, however, may render a target sewing line difficult to identity and modify.

### SUMMARY

Embodiments relate to sewing of a garment. A piece of the garment is displayed at a first depth level. A user input to select a pattern to display an exploded view at a second depth level is received. A selected pattern for the second depth level from different patterns of the piece of the garment is identified. One or more guide lines connecting sewing lines associated with the selected patterns to indicate matching of the sewing lines, according to sewing line matching information are displayed. The sewing line matching information indicates matching of the sewing lines in the different patterns of the piece of the garment.

In one or more embodiments, an exploded view of the piece at the first depth level with the different patterns is displayed separated from each other by predetermined distances when a request to display the exploded view of the piece at the first depth level is received.

One or more guide lines extending between the sewing lines of the different patterns are displayed to indicate matching of the sewing lines of the different patterns, according to the sewing line matching information.

In one or more embodiments, the one or more of the guide lines extending between the sewing lines of the different patterns are displayed further with different colors, different transparency levels or both different colors and different transparency levels.

In one or more embodiments, matching sewing lines and a guide line connecting the matching sewing lines are displayed with the same color, a same transparency level or both the same color and the same transparency levels.

In one or more embodiments, a subset of the sewing lines not associated with the selected pattern is not displayed at the second depth level but displayed at the first depth level.

In one or more embodiments, another user input indicating editing at least one subset of the sewing lines at the second depth level is received. The at least one subset of the sewing lines as edited by the other user input is displayed.

In one or more embodiments, the editing of the at least one subset of the sewing lines includes moving an end point of the at least one subset of the sewing lines.

In one or more embodiments, different patterns other than the selected pattern are not displayed in the second depth level.

In one or more embodiments, user interface elements for editing different patterns other than the selected pattern at the second depth level are disabled.

In one or more embodiments, user interface elements for editing features or characteristics applicable to each of the different patterns in the piece at the first depth level are enabled.

In one or more embodiments, another piece of the garment is displayed in a manner different from the piece of the garment at the first depth level.

In one or more embodiments, the selected pattern and one or more adjacent patterns are displayed at enlarged distances at the second depth level. The enlarged distances are larger than predetermined distances between the selected pattern and the one or more adjacent patterns at the first depth level.

In one or more embodiments, another user input indicating deleting of a subset of the guide lines connecting two sewing lines is received. The sewing line matching information is updated to delete the matching of the two sewing lines connected by the subset of the guide lines.

In one or more embodiments, more than two sewing lines are indicated as being matched in the sewing line matching information.

In one or more embodiments, a style line that defines an outline or style of a pattern of the different patterns at the second depth level is received. A first sewing line on the pattern at one side of the style line, a second sewing line on the pattern at the other side of the style line, and one or more additional guide lines connecting the first sewing line and the second sewing line are generated.

In one or more embodiments, the first sewing line, the second sewing line and the one or more additional guide lines are displayed. At least one of the first sewing line or second sewing line is edited when another user input is received. Edited versions of the first sewing line or the second sewing lines are displayed. Updated versions of the one or more additional guide lines connecting the edited versions of the first sewing line or the second sewing line are displayed.

### BRIEF DESCRIPTION OF DRAWINGS

FIG. 1 is a flowchart illustrating a method of displaying sewing lines in a garment, according to an example embodiment.

FIGS. 2A and 2B are exploded views illustrating sewing lines at a first depth level, according to an example embodiment.

FIGS. 3A and 3B are exploded views illustrating sewing lines of a pattern at a second depth level, according to an example embodiment.

FIG. 4 is a two-dimensional diagram illustrating configurations of patterns where three patterns have a matching sewing line, according to an example embodiment.

FIG. 5 are exploded views illustrating an embodiment where sewing lines of three patterns match a sewing line of a pattern in a 3D exploded view, according to an example embodiment.

FIG. 6 are diagrams illustrating editing of sewing lines through adjusting of a style line, according to an example embodiment.

FIG. 7 is a block diagram illustrating a simulation device according to various example embodiments.

### DETAILED DESCRIPTION

The following structural or functional descriptions are exemplary to merely describe the example embodiments, and the scope of the example embodiments is not limited to the descriptions provided in the present specification.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more of other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Three-dimensional (3D) garments and two-dimensional (2D) patterns may include meshes, each including a plurality of polygons. The meshes may be modeled in various manners. For example, vertices of a polygon included in the mesh may be point masses and sides of the polygon may be represented as elastic springs which connect the point masses (a mass-spring model). Springs may have respective resistance values against, for example, stretch, shear, and bending, depending on the properties of the material of fabric used. Alternatively, the mesh may be modeled using a strain model. A polygon included in the mesh may be modeled, for example, as a triangle or a polygon having four or more sides. In some examples, when modeling a 3D volume, the mesh may be modeled as a 3D polyhedron.

The vertices of the polygon(s) included in the mesh may be moved by an external force, such as gravity, and an internal force, such as stretch, shear, and bending. Where a force applied to each vertex is obtained by calculating the external force and the internal force, the speed of displacement and movement of each vertex may be obtained. Movements of the garment may be simulated through the movements of the vertices of the polygon(s) constituting the mesh in each time step. For example, where a garment configured as a polygonal mesh is draped over a 3D avatar, a natural 3D virtual garment based on the law of physics may be implemented. The vertices of the polygon(s) included in the mesh may move according to the action of an external force, such as gravity, and the action of an internal force, such as stretch, shear, and bending. When a force being applied to each vertex is obtained by calculating the external force and the internal force, the speed of movement and displacement of each vertex may be obtained. In addition, a movement of the virtual garment may be simulated, based on movements of the vertices of the polygons of the mesh in each time step. Where a 2D pattern formed of a polygonal mesh is draped over a 3D avatar, a 3D virtual garment in a natural look based on the law of physics may be implemented.

A 3D garment may include, for example, at least one virtual garment suitable for a user's body size, a virtual garment for a 3D virtual character, and a virtual garment for a 3D virtual avatar.

The 3D garment may be generated by contacting one of the outlines of a 2D pattern with one of the outlines of another 2D pattern and connecting the two outlines, that is, sewing the two outlines. Sewing a virtual garment may be implemented by attaching one mesh among the outlines of a 2D pattern to one mesh among the outlines of another 2D pattern to be sewn to generate a 3D garment. More specifically, there may be polygonal vertices of a mesh included in two 2D patterns on the outlines of the two 2D patterns. Where a user provides an outline and a length (hereinafter, ‘a sewing line’) for setting a sewing operation, sewing for a virtual garment may be implemented by joining the polygonal vertices of the mesh on a sewing line in each of the two 2D patterns.

The start and end of each sewing line may be polygonal vertices of a certain mesh. Where the number of polygonal vertices, provided by a user, on a sewing line does not match the number of polygonal vertices on another sewing line, meshes of the 2D patterns may be updated to create new meshes so that the number of polygonal vertices on the two sewing lines match. Then, the polygonal vertices corresponding to each other on the two sewing lines may be connected to perform sewing of a 3D virtual garment.

Hereinafter, examples will be described in detail with reference to the accompanying drawings. In the drawings, like reference numerals are used for like elements.

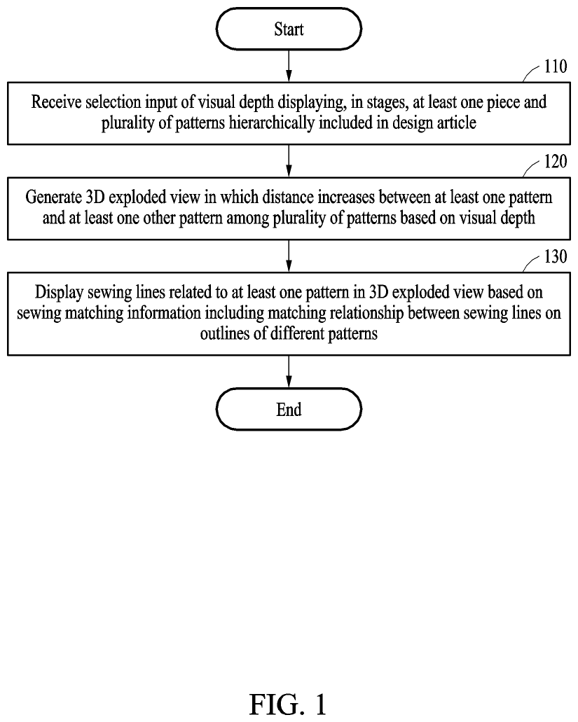

FIG. 1 is a flowchart illustrating a method of sewing in a design article, according to an embodiment. In operation 110, a simulation device may receive an input of selecting a visual depth for display of an article where the garment is hierarchically structured to include at least one piece of the article, and at least one piece of the article includes a plurality of patterns.

The article described herein refers to independent and concrete tangible movables. The design article described herein refers to an article designed to create a sense of visual aesthetics. The design article may include, but is not limited to, a garment, shoes, accessories, a bag, and a hat. The design article may include at least one piece. For example, where the design article is a garment, the garment may include a top piece and a bottom piece. In turn, the piece may include a plurality of patterns. For example, where the piece is a T-shirt for the upper body, the T-shirt may include a front body pattern, a back body pattern, a sleeve pattern, and the like.

According to an example embodiment, in operation 120, a 3D exploded view may be generated. In the exploded view, distances between patterns are increased to show the design article dismantled and separated from one another. Such an increase in the distance may allow a user to perform delicate work, such as modifying a sewing line, a material, or size, for each pattern included in a pattern of a design image by easily identifying and manipulating different patterns. After increasing the distance between the pieces, distances between a plurality of patterns included in each of the pieces may be increased. Since in the 3D exploded view, the distances between the patterns increase while the overall shape of a 3D garment is maintained as much as possible, a user may easily understand the context of the pieces and patterns in the 3D garment.

According to an example embodiment, a simulation device may store sewing line matching information indicating a matching relationship between sewing lines on outlines of different patterns. The sewing line information may be received from a user or other sources, or be generated through an automated process. For example, the user may create or modify a sewing line on the simulation device that displays the 3D exploded view. Since patterns are joined along a plurality of matching sewing lines, a pair of matching sewing lines may form a single line on the design article. Accordingly, the pair of matching sewing lines may be expressed as a single line in the 3D simulation of the design article.

After the user designs a specific garment and provides a sewing line, data on the design of the garment may be updated and stored with the sewing line matching information that identifies the sewing line. Where the user loads a file of a garment design, the simulation device may also load the sewing line matching information corresponding to the design of the garment to display sewing lines in the 3D exploded view.

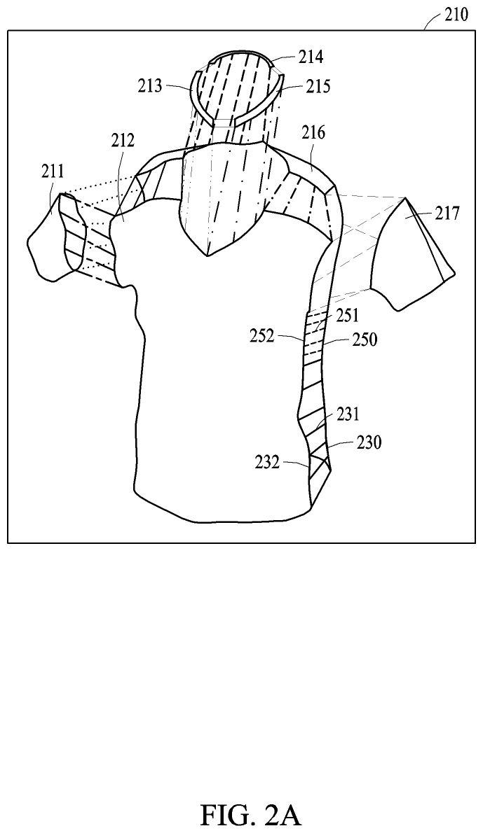

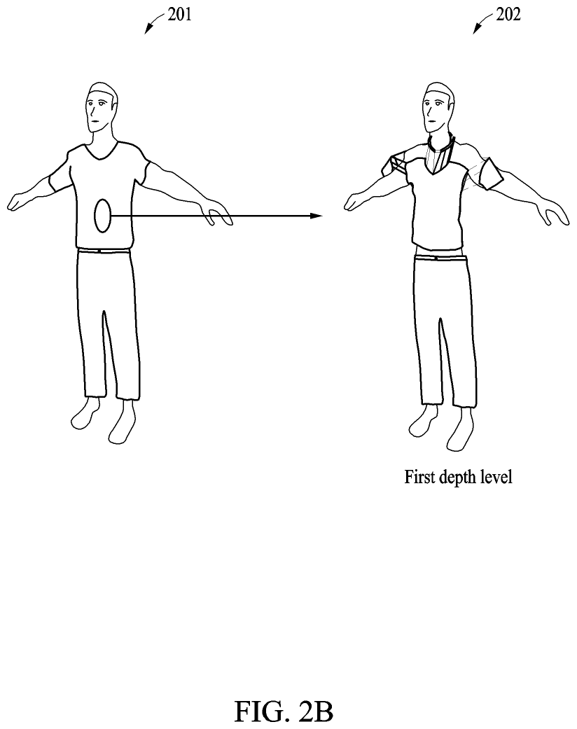

In operation 130, the plurality of sewing lines related to a selected piece are determined and displayed, based on the sewing line matching information. The sewing line matching information may include a matching relationship between sewing lines on the outlines of different patterns. The design article may include at least one piece. Where the simulation device receives an input from the user selecting one of the pieces, the simulation device may display sewing lines associated with the selected piece (e.g., T-shirt of FIG. 2A). All sewing lines included in the selected piece may be displayed. Such a display may allow a user to edit a sewing line for a specific selected piece. In another example, where a piece includes a top piece and a bottom piece, the user may select the top piece. In this case, the simulation device may display all the sewing lines related to the top piece and may not display the sewing lines of the bottom piece. The simulation device may generate a 3D exploded view of the upper piece by increasing distances between patterns of the selected top piece to predetermined lengths but not generate a 3D exploded view of the bottom piece that was not selected.

In a sewing line editing mode, the simulation device may generate the 3D exploded view of the selected piece while not displaying the unselected piece on a screen. The sewing line editing mode described herein refers to a mode that allows a user to edit features or characteristics of patterns or pieces such as sewing lines in a 3D simulation. In this mode, the user may edit the length of a sewing line or delete the sewing line.

The simulation device may display sewing lines related to the selected piece determined based on an input of selecting one piece at the selected visual depth and input in the sewing line editing mode, and guide lines, which connect the sewing lines. In addition, the simulation device may display no piece other than the selected piece. Therefore, the simulation device may output only the piece selected by the user, and the sewing lines and guide lines related to the piece on the screen, so that the user may intensively edit only the piece selected by the user as an editing target.

The simulation device may display a plurality of sewing lines, which is related to a selected pattern determined based on an input of selecting one pattern at the selected visual depth in the sewing line editing mode, and guide lines, which connect the sewing lines. In addition, the simulation device may not display sewing lines, which are related to at least one pattern other than the selected pattern, and guide lines connecting the sewing lines. Furthermore, the simulation device may not display the piece that does not include the selected pattern. Therefore, the simulation device may display only the piece including the selected pattern and sewing lines and guide lines, which are related to the selected pattern. In addition, the simulation device may not display the piece, sewing lines, and guide lines that are not related to the selected pattern. This may allow the user to intensively edit the selected pattern, which is an editing target.

The simulation device may generate a 3D exploded view of the selected piece in a sewing line generation mode. In addition, the simulation device may generate a 3D exploded view of the unselected pieces. Accordingly, in the sewing line generation mode, all pieces of a design article may be expressed in the 3D exploded view. The sewing line generation mode may be a mode in which a user may generate a sewing line in a 3D simulation. The user may create a new sewing line on a pattern in the sewing line generation mode.

The simulation device may display a plurality of sewing lines related to the selected piece determined based on an input of selecting one piece in a selected visual depth in the sewing line generation mode. In addition, the simulation device may display at least one piece other than the selected piece. The at least one piece other than the selected piece may include a piece other than the selected piece among a plurality of pieces included in the design article. Accordingly, the simulation device may display a 3D exploded view of all the pieces included in the design article in the sewing line generation mode. This is because patterns included in different pieces may be connected to each other. Accordingly, the simulation device may display the 3D exploded views of other pieces in addition to the 3D exploded view of the selected piece in the sewing line generation mode, unlike the sewing line editing mode.

Hereinafter, generating and editing a sewing line is described in detail. A user may create a new sewing line on a pattern. In addition, existing or newly created sewing lines may be edited.

The simulation device may generate a first sewing line that is at least a part of the outline of a first pattern and a second sewing line that is at least a part of the outline of a second pattern, based on a selection input of the user. The second sewing line may match the first sewing line. The first pattern and the second pattern may be patterns included in the same piece or may be patterns included in different pieces. The simulation device may generate guide lines connecting the first sewing line to the second sewing line.

The selection input of the user may include two ending points of a sewing line. The user may input the ending points of the sewing line in a pattern. The simulation device may generate a sewing line connecting the ending points. The length of the generated sewing line may not necessarily match the length of the outline of the pattern or a distance between two points on the outline. The length of the generated sewing line may be determined based on the ending points input by the user. The lengths between sewing lines matched to each other may be the same or different. For example, the length of the first sewing line may be the same or different from the length of the second sewing line.

The simulation device may edit at least one of the first sewing line and the second sewing line. Editing the sewing line may include modifying the length of the sewing line or deleting the sewing line. Modifying the length of the sewing line may be completed by changing the position of one end point of the sewing line. Where the user inputs a movement of an end point of the sewing line, the simulation device may modify the length of the sewing line and output the modified sewing line in the 3D simulation. Where the length of at least one of the first sewing line and the second sewing line is modified, the simulation device may change the guide lines connecting the first sewing line to the second sewing line. The simulation device may change the guide lines based on the modified length of the sewing line. When the length of at least one of the first sewing line and the second sewing line is modified, the length of sewing the two patterns may be modified. Deleting a sewing line may be refer to an operation of deleting a pair of matched sewing lines. The simulation device may delete a selected pair of sewing lines based on a selection input of a user. Where the selected pair of sewing lines is generated, the simulation device may delete a matching relationship between the pair of sewing lines and delete guide lines connecting the pair of sewing lines in the 3D simulation.

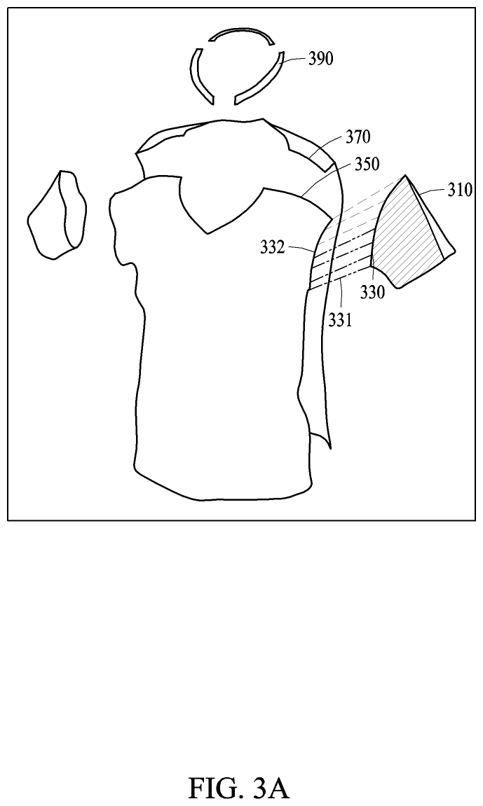

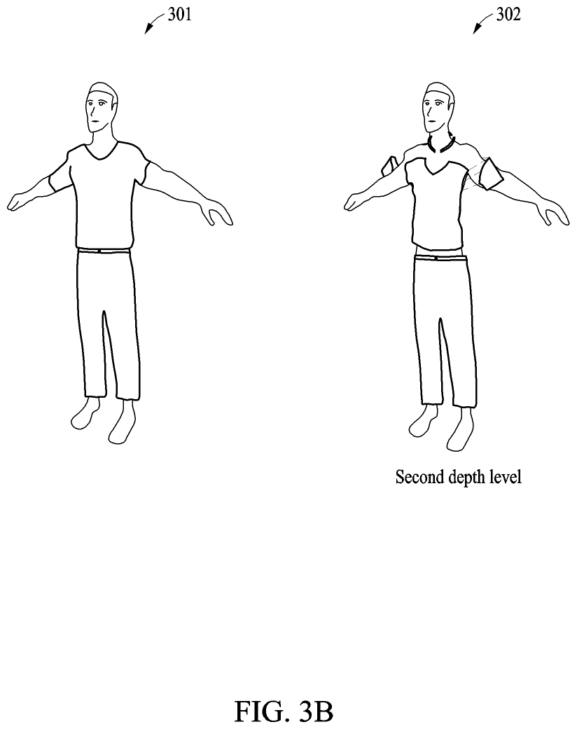

In operation 130, the simulation device may display a plurality of sewing lines related to a selected pattern determined based on an input of selecting one of the patterns. A plurality of patterns may be included in one piece. Where the user inputs the selection of one of the plurality of patterns, a plurality of sewing lines included in the selected pattern may be displayed. In addition, the simulation device may display sewing lines included in the selected pattern and sewing lines respectively matching the sewing lines. Referring to FIG. 3A, a piece may be a T-shirt, and the T-shirt may include a plurality of patterns. A user may select a sleeve pattern. In this case, the sleeve pattern may be a selected pattern. The simulation device may display all sewing lines 330 and 332 related to the selected pattern. Furthermore, the simulation device may display a plurality of guide lines 331 related to the selected pattern.

The simulation device may display a plurality of sewing lines related to the selected pattern while not displaying a plurality of sewing lines not related to the selected pattern. For example, the simulation device may display the plurality of sewing lines related to the selected pattern as solid lines having a specific color. On the other hand, the simulation device may not display sewing lines not associated with the selected pattern.

The simulation device may generate a plurality of guide lines connecting matching sewing lines as indicated by sewing line matching information. The guide lines described herein refer to lines that connect matching sewing lines. The simulation device may display guide lines connecting to the selected pattern while not displaying guide lines not connected to the selected pattern. In this way, a user may easily modify a sewing line related to the pattern selected by the user as a working target on a screen.

FIGS. 2A and 2B are exploded views illustrating sewing lines at a first depth level, according to an example embodiment. FIG. 2A illustrates a T-shirt piece 210 that includes patterns 211, 212, 213, 214, 215, 216, 217, sewing line 232, 230, 250, 252, and guide lines 231, 251.

Sewing line matching information may include matching information between a first sewing line generated on at least a part of the outline of a first pattern and a second sewing line generated on at least a part of the outline of a second pattern. Referring to FIG. 2A, the sewing line 232 on the outline of the pattern 212 and the sewing line 230 on the outline of the pattern 216 may be sewing lines matched to each other. When the user generates the sewing line 232 on the outline of the pattern 212 and then generates the sewing line 230 on the outline of the pattern 216, the sewing line matching information about a matching relationship between the sewing line 232 and the sewing line 230 may be generated. The simulation device may store such sewing line matching information corresponding to the sewing lines.

The simulation device may generate a plurality of guide lines connecting the matched sewing lines, based on the sewing line matching information. For example, the simulation device may generate the guide lines 231 based on the sewing line matching information between the sewing line 232 and the sewing line 230. Although multiple guide lines connecting two matching sewing lines are illustrated in FIG. 2A, only a single guide line may be used to connect the two matching sewing lines. The simulation device may generate the guide lines 251 based on the sewing line matching information between the sewing line 250 and the sewing line 252.

The simulation device may set at least one of a color or a transparency of a pair of the sewing lines in a different manner. For example, the simulation device may set a pair of the sewing lines 230, 232 to yellow, and a pair of the sewing lines 250, 252 to red. In this way, a user may easily distinguish between different sewing lines on the outline of the same pattern.

The simulation device may set at least one of a color and a transparency of matched sewing lines and guide lines connecting the matched sewing lines to be the same. For example, at least one of the color and the transparency of the sewing lines 232, 230 may set to be the same. In another example, at least one of the color and the transparency of the guide lines 231 may be set to be the same as at least one of the color and the transparency of the sewing lines 232 and 230. Similarly, the simulation device may set at least one of the color or the transparency of the sewing line 250, the guide lines 251, and the sewing line 252 to be the same.

FIG. 2B illustrates sewing lines where the T-shirt piece is selected at a first depth level. Avatars shown in FIG. 2B may or may not be displayed in a 3D simulation. Where the avatars are not displayed, only design items (e.g., pieces or patterns) may be displayed. A simulation device 600 may determine a depth level by receiving an input of selecting a visual depth. The depth level may include at least one of: a level displaying an entire garment, a level displaying pieces, and a level displaying patterns. As an example, a level at which one selected piece is activated to display sewing lines included in the selected piece may be a first depth level.

The first depth level is a level at which the entire 3D garment may be modified. Where the depth level currently being displayed is the ‘first depth level,’ a piece may be displayed on the screen. In the first depth level, a user interface for modifying the piece selected by the user in the 3D garment may be visualized. In the example of FIG. 2B, it is assumed that the 3D garment displayed on the screen includes two pieces for a top and a bottom, with the top piece being selected by the user. The simulation device may display user interface elements for modifying the selected top piece at a high level, and the unselected bottom piece may be made transparent or translucent.

As shown in FIG. 2B, a T-shirt piece (top piece) may be selected at a level 201 that displays an entire garment. As an example, the simulation device may receive an input of selecting the first depth level while the entire garment is being displayed at level 201. In addition, the simulation device may receive an input of selecting a piece in the garment. The simulation device 600 may display sewing lines included in the piece selected at a first depth level 202. The simulation device 600 may display all sewing lines connecting patterns included in the T-shirt piece in the first depth level 202. Detailed sewing lines displayed at the first depth level 202 may be displayed as shown in FIG. 2A.

FIGS. 3A and 3B are exploded views illustrating sewing lines of a pattern at a second depth level, according to an example embodiment. FIG. 3A illustrates as, a selected pattern, a sleeve pattern 310, and its sewing lines 330, 332, guide lines 331, a front body pattern 350, a back body pattern 370, and a collar pattern 390.

In the second depth level, a selected pattern and patterns adjacent to the selected pattern may be separated by distances larger than their corresponding distances at the first depth level. For example, the selected pattern may be the sleeve pattern 310 and the patterns adjacent to the sleeve pattern 310 may be patterns connecting to the sleeve pattern 310 by sewing or be relatively closely located with the sleeve pattern 310. For example, the patterns adjacent to the sleeve pattern 310 may be the collar pattern 390, the front body pattern 350, and the back body pattern 370. The simulation device may set distances between the sleeve pattern 310 (selected pattern) and other adjacent patterns (the collar pattern 390, the front body pattern 350, and/or the back body pattern 370) in the second depth level to be larger than the distances in the first depth level. In this way, a user may easily edit a sewing line related to a pattern (e.g., the sleeve pattern) determined as an editing target without inadvertently taking actions related to other patterns in a crammed display region.

FIG. 3B illustrates sewing lines displayed where a pattern included in a piece is selected at a second depth level. Avatars shown in FIG. 3B may or may not be displayed in a 3D simulation. Where the avatars are not displayed, only design items (e.g., pieces or patterns) may be displayed. The simulation device 600 may determine a depth level according to a user input of selecting a visual depth. The depth level may include at least one of: a level displaying an entire garment, a level displaying pieces, and a level displaying patterns. As an example, a level at which a selected pattern is activated to display sewing lines may be a second depth level.

The second depth level is a level at which modification may be made to the garment at a finer detail relative to the first depth level. Unlike the first depth level, only the modifications of the patterns included in a target piece may be enabled but modifications of other pieces are disabled. The simulation device may enable or display user interface elements for modifying the pattern selected by the user while disabling or not displaying user interface elements for modifying patterns not selected by the user.

As shown in FIG. 3B, a pattern included in a T-shirt piece, which is a top piece, may be selected at a level 301 that displays the entire garment. As an example, the simulation device 600 may receive an input for selecting the second depth level. In addition, the simulation device 600 may receive an input of selecting at least one pattern from among patterns included in the T-shirt piece. The simulation device 600 may display sewing lines related to the selected pattern, corresponding to a second depth level 302.

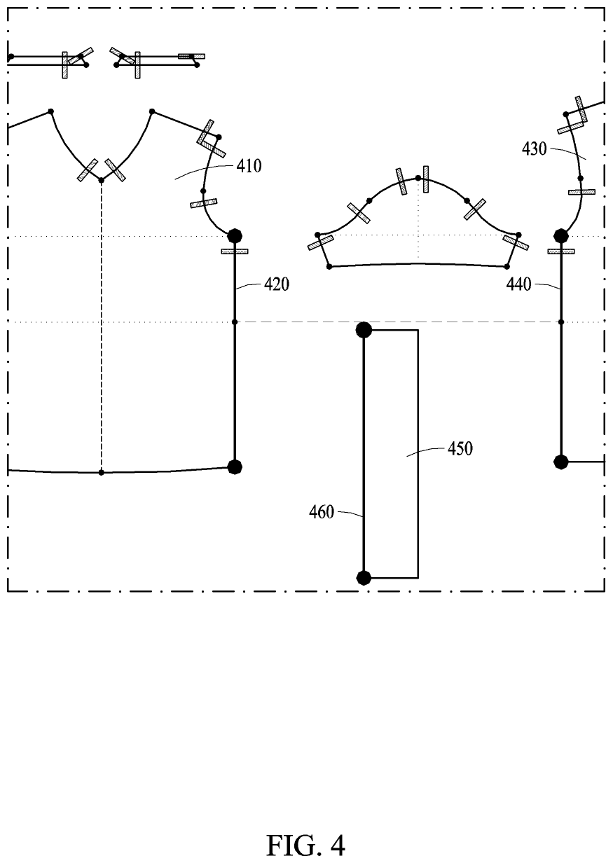

FIG. 4 is a two-dimensional diagram illustrating configurations of patterns where three patterns have a single matching sewing line, according to an example embodiment. There may be more than two matching sewing lines of different patterns. The simulation device may receive a selection of a pair of sewing lines and the two or more sewing lines matching the sewing line of the pattern in response to displaying a 3D exploded view.

In the example of FIG. 4, sewing line 420 may match sewing line 440 as well as sewing line 460. The sewing lines 420, 440 may be in a matching relationship with each other while the sewing line 420, 460 may also be in a matching relationship with each other. In this case, in a 3D garment simulation, the sewing lines 420, 440, 460 may overlap with each other as a single line in the assembled garment because patterns 410, 430, 450 may be patterns connected by the single line.

A user may select each sewing line to modify the sewing line. For example, the matching relationship between the sewing lines 420, 440 may be intended by the user, but the matching relationship between the sewing lines 420, 460 may not have been intended. In this case, the user may select and modify the sewing line 460. A simulation device may allow the user to select each of the sewing lines 420, 440, 460 to efficiently edit the sewing lines.

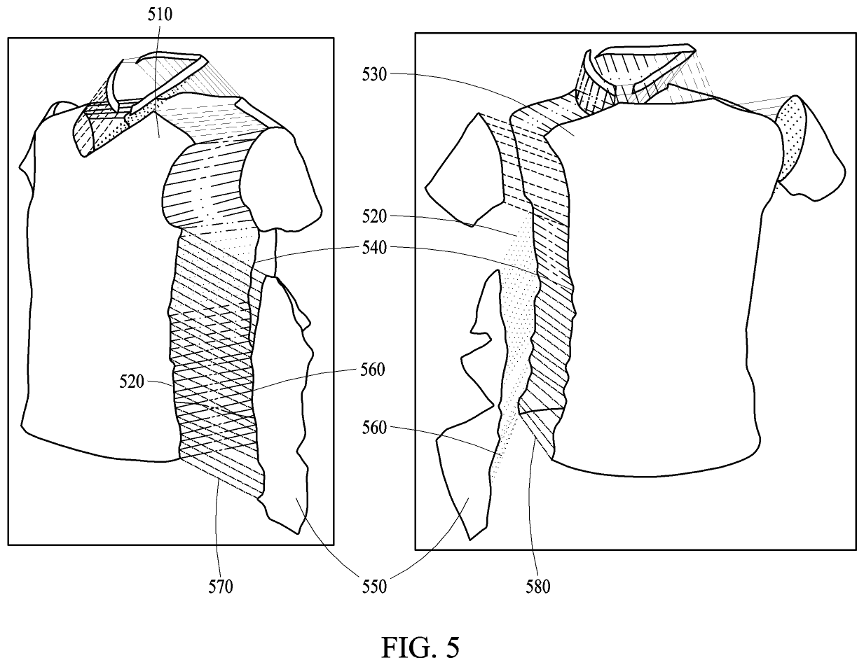

FIG. 5 are exploded views illustrating an embodiment where sewing lines of three patterns match a sewing line of a pattern in a 3D exploded view, according to an example embodiment. In the 3D exploded view, patterns 510, 530, 550 may correspond to the patterns 410, 430, 450 of FIG. 4, respectively. Further, sewing lines 520, 540, 560 may correspond to the sewing lines 420, 440, 460 of FIG. 4, respectively.

A simulation device may allow a user to easily determine whether two or more sewing lines match a sewing line of a pattern in the 3D exploded view through visualization. Since the sewing lines 520, 540 are in a matching relationship, there may be guide lines 570 displayed between the sewing lines 520, 540. In addition, since the sewing lines 520, 560 are in a matching relationship, there may be guide lines 580 displayed between the sewing lines 520, 560. Since guide lines are generated based on sewing line matching information, the simulation device may allow the user to easily determine whether two or more sewing lines match one sewing line in the 3D exploded view through visualization. Since sewing lines matched to each other may not overlap each other in the 3D exploded view, the user may accurately determine that there are two or more sewing lines matching a sewing line, and select each pair of matched sewing lines for modification.

Where there are two or more sewing lines matching a sewing line of a pattern, the simulation device may receive a selection of guide lines connecting the sewing line of the pattern to the two or more sewing lines matching the sewing line of the pattern in the 3D exploded view. For example, since the sewing line 520 and the sewing line 540 are in a matching relationship, the plurality of guide lines 570 may be displayed between the sewing line 520 and the sewing line 540. In addition, since the sewing line 520 and the sewing line 560 are in a matching relationship, the plurality of guide lines 580 may be displayed between the sewing line 520 and the sewing line 560. The simulation device may receive an input of selecting the guide lines 570 or the guide lines 580 from the user. Where the guide lines are selected, a pair of sewing lines connecting to the guide lines may also be selected.

The simulation device may delete the selected guide lines when a user input indicating deleting of the selected guide lines is received. For example, where a user input of selecting the guide lines 570 followed by another user input indicating deleting of the guide lines 570 is received, the simulation device may delete the selected guide lines 570. The simulation device may delete the selected guide lines and delete the matching relationship between sewing lines connected by the selected guide lines. For example, the simulation device may delete the matching relationship between the sewing lines 520, 540 connected by the selected guide lines 570.

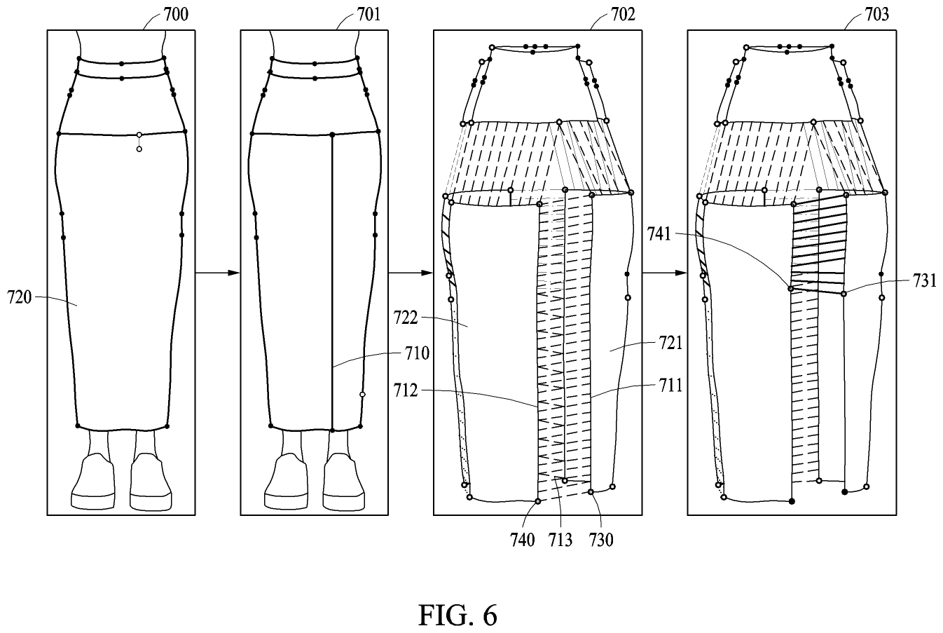

FIG. 6 are diagrams illustrating editing of sewing lines through adjusting of a style line, according to an example embodiment. A style line described herein is a line that defines an overall outline or style of a 3D garment or its parts. The style line may be inside a pattern and may be generated arbitrarily by a user under certain conditions. Two end points of the style line may be points on the pattern. Where the style line is generated on the pattern, the pattern including the style line may be automatically divided along the style line inside the pattern, and a pair of sewing lines may be generated alongside or parallel to the style line.

The user may generate the style line on the pattern to transform the overall shape or style of a 3D garment. For example, where the style line is generated on a pattern, the pattern may be divided into two patterns, based on the style line, and a sewing line and guide lines may be generated in each of the divided patterns, based on the style line. Accordingly, there may be sewing lines in the outlines of the divided patterns and connected sewing lines may be the style line.

The selection input of the user may be an input of generating the style line on the pattern. On screen 700, the user may provide user inputs to generate a style line on a pattern as shown in screen 701.

The simulation device may automatically generate a first sewing line, a second sewing line, and guide lines, based on the style line. Referring to FIG. 6, the pattern 720 may be divided into a first pattern 721 and a second pattern 722, as shown in screen 702. A first sewing line 711 may be on the left outline of the first pattern 721. A second sewing line 712 may be on the right outline of the second pattern 722. The first sewing line 711 and the second sewing line 712 may be in a matching relationship. In addition, the simulation device may automatically generate and display guide lines 713 connecting the first sewing line 711 and the second sewing line 712.

The simulation device may edit at least one of the first sewing line 711 or the second sewing line 712. The user may provide a user input indicating the modification of the length of the first sewing line 711 or a modification of the length of the second sewing line 712. For example, the user may adjust the length of the first sewing line 711 by adjusting the position of end point 730 of the first sewing line 711. Referring to FIG. 6, the position of the end point 730 may move to the position of point 731 as shown in screen 703. As the length of the sewing line is modified by moving up the location of the end point, guide lines connecting the sewing line may be modified and displayed accordingly. The simulation device may determine the modified length of the first sewing line 711 or the modified length of the second sewing line 712, based on the user input. In addition, the simulation device may modify the guide lines 713 based on at least one of the modified length of the first sewing line 711 and the modified length of the second sewing line 712. Since the lengths of the two patterns to be sewn are different, the design article in appearance may vary in the 3D garment simulation.

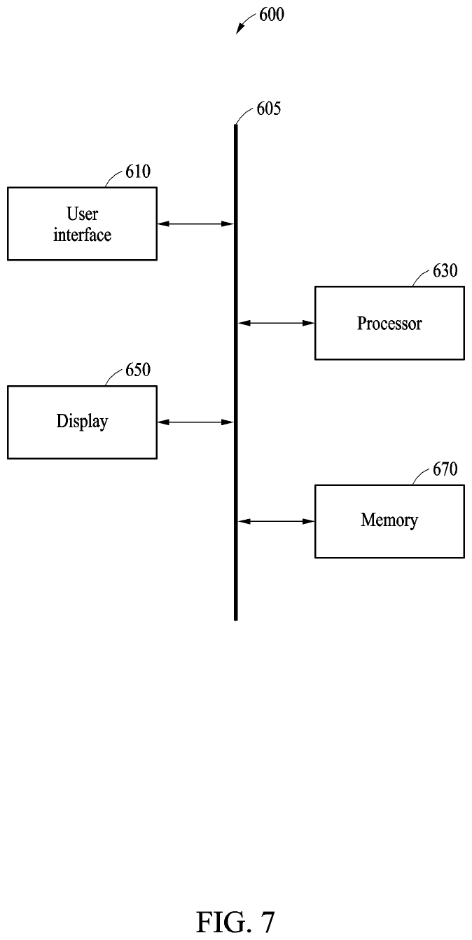

FIG. 7 is a block diagram illustrating a simulation device according to various example embodiments. A simulation device 600 may be a server or a terminal. A simulation device according to various example embodiments may be one of various types of devices. The simulation device may include, for example, a portable communication device (e.g., a smartphone), a computer device, a portable computing device, a camera, a wearable device, or a tablet device. Referring to FIG. 7, the simulation device 600 may include a user interface 610, a processor 630, a display 650, and a memory 670. The communication interface 610, the processor 630, the display 650, and the memory 670 may be connected to each other via a communication bus 605.

A visual depth may refer to a degree of visualization of a garment (e.g., pieces and patterns) that are output on a screen where a user modifies the garment. Accordingly, the degree of visualization of the garment output on the screen may vary depending on a change in the visual depth. The visual depth may include multiple depth levels, a user may select a depth level for modification from among depth levels hierarchically displaying pieces included in a 3D garment and patterns included in each of the pieces in a 3D exploded view (e.g., a 3D garment worn by an avatar in a simulation), so that even targets, which are modifiable in a 3D simulation space yet intricately entangled, may be clearly separated enough for visualization and/or modification.

According to an example embodiment, an operation mode of the simulation device may be set to be a work mode, which performs editing functions available for each depth level, and a movement mode, which switches depth levels, so that the user may smoothly switch the depth levels and work at the switched depth level.

The user interface 610 may receive a user's input of selecting any one of a plurality of objects corresponding to a next level of the currently displayed depth level from among depth levels hierarchically displaying one or more pieces included in a 3D garment worn by an avatar and patterns (2D patterns) included in each piece. The user interface 610 may receive an input of the user for a 3D garment, pieces, and/or patterns displayed in a 3D space, for example, via a stylus pen, a mouse click, and/or a touch input of the user's finger.

In addition, the user interface 610 may receive an input from the user for an empty space other than objects in the simulation space where the objects are displayed.

The processor 630 may activate and render a selected piece and/or pattern. In addition, the processor 630 may inactivate at least one remaining piece and/or pattern other than the selected piece and/or pattern, so that the at least one remaining piece and/or pattern may be transparent or translucent.

For example, where a next depth level is the first level displaying pieces, the processor 630 may activate and render any one piece selected in response to the first level. Where the next depth level is the second level displaying patterns, the processor 630 may activate and render a pattern selected in response to the second level. In this case, where the selected pattern is covered by other unselected 2D patterns, the processor 630 may clearly render the selected 2D pattern through the other 2D patterns.

For example, where the user interface 610 receives an input of the user for a remaining empty space other than objects in the simulation space, the processor 630 may not display a next depth level in response to the input of the user for the empty space and may maintain the currently displayed depth level.

The display 650 may display a 3D exploded view generated by the processor 630.

The memory 670 may store the generated 3D exploded view, sewing line information, and the like. Furthermore, the memory 670 may store various pieces of information generated by a processing process of the processor 750 described above. In addition, the memory 670 may store a variety of data and programs. The memory 670 may include a volatile memory or a non-volatile memory. The memory 670 may include a large-capacity storage medium, such as a hard disk, to store a variety of data.

Furthermore, the processor 630 may perform at least one of the methods described with reference to FIGS. 1 through 5 or an algorithm corresponding to at least one of the methods.

The processor 630 may be a hardware-implemented data processing device having a circuit that is physically structured to execute desired operations. For example, the desired operations may include code or instructions included in a program. The processor 630 may be implemented as, for example, a central processing unit (CPU), a graphics processing unit (GPU), or a neural network processing unit (NPU). For example, the simulation device 600 implemented as hardware may include, for example, a microprocessor, a CPU, a processor core, a multi-core processor, a multiprocessor, an application-specific integrated circuit (ASIC), and a field-programmable gate array (FPGA).

The processor 630 may execute a program and control the simulation device 600. Code of the program executed by the processor 630 may be stored in the memory 670.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files including higher-level code that may be executed by a computer using an interpreter. The above-described devices may be configured to function as one or more software modules in order to perform the operations of the above-described embodiments, or vice versa.

The software may include a computer program, a piece of code, an instruction, or some combination thereof, to independently or uniformly instruct or configure a processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording media.

While this disclosure includes specific examples, it will be apparent to one of ordinary skill in the art that various changes in form and details may be made in these examples. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A method of simulating sewing, comprising:
displaying a piece of a garment at a first depth level;
receiving a user input to select a pattern to display an exploded view at a second depth level;
identifying a selected pattern for the second depth level from different patterns of the piece of the garment; and
displaying one or more guide lines connecting sewing lines associated with the selected patterns to indicate matching of the sewing lines, according to sewing line matching information,
wherein the sewing line matching information indicates matching of the sewing lines in the different patterns of the piece of the garment.

2. The method of claim 1, further comprising:
responsive to receiving a request to display an exploded view of the piece at the first depth level, displaying the exploded view of the piece at the first depth level with the different patterns separated from each other by predetermined distances; and
displaying one or more guide lines extending between the sewing lines of the different patterns to indicate matching of the sewing lines of the different patterns, according to the sewing line matching information.

3. The method of claim 2, wherein the one or more of the guide lines extending between the sewing lines of the different patterns are displayed further with different colors, different transparency levels or both different colors and different transparency levels.

4. The method of claim 3, wherein matching sewing lines and a guide line connecting the matching sewing lines are displayed with a same color, a same transparency level or both the same color and the same transparency levels.

5. The method of claim 1, wherein a subset of the sewing lines not associated with the selected pattern is not displayed at the second depth level but displayed at the first depth level.

6. The method of claim 1, further comprising:
receiving another user input indicating editing at least one subset of the sewing lines at the second depth level; and
displaying the at least one subset of the sewing lines as edited by the other user input.

7. The method of claim 6, wherein the editing of the at least one subset of the sewing lines comprises moving an end point of the at least one subset of the sewing lines.

8. The method of claim 1, wherein different patterns other than the selected pattern are not displayed in the second depth level.

9. The method of claim 1, further comprising disabling user interface elements for editing different patterns other than the selected pattern at the second depth level.

10. The method of claim 1, further comprising enabling user interface elements for editing features or characteristics applicable to each of the different patterns in the piece at the first depth level.

11. The method of claim 1, further comprising displaying another piece of the garment in a manner different from the piece of the garment at the first depth level.

12. The method of claim 1, wherein the selected pattern and one or more adjacent patterns are displayed at enlarged distances at the second depth level, the enlarged distances larger than predetermined distances between the selected pattern and the one or more adjacent patterns at the first depth level.

13. The method of claim 1, further comprising:
receiving another user input indicating deleting of a subset of the guide lines connecting two sewing lines; and
updating the sewing line matching information to delete the matching of the two sewing lines connected by the subset of the guide lines.

14. The method of claim 1, wherein more than two sewing lines are indicated as being matched in the sewing line matching information.

15. The method of claim 1, further comprising:
receiving a style line that defines an outline or style of a pattern of the different patterns at the second depth level; and
generating a first sewing line on the pattern at one side of the style line, a second sewing line on the pattern at the other side of the style line, and one or more additional guide lines connecting the first sewing line and the second sewing line.

16. The method of claim 15, further comprising:
displaying the first sewing line, the second sewing line and the one or more additional guide lines;
editing at least one of the first sewing line or second sewing line responsive to receiving another user input;
displaying edited versions of the first sewing line or the second sewing lines; and
displaying updated versions of the one or more additional guide lines connecting the edited versions of the first sewing line or the second sewing line.

17. A non-transitory computer-readable storage medium storing instructions thereon, the instructions when executed by a processor cause the processor to perform the method of claim 1.

18. A computing device comprising:
a processor; and
a memory storing instructions thereon, the instructions when executed by the processor cause the processor to:
display a piece of a garment at a first depth level,
receive a user input to select a pattern to display an exploded view at a second depth level,
identify a selected pattern for the second depth level from different patterns of the piece of the garment, and
display one or more guide lines connecting sewing lines associated with the selected patterns to indicate matching of the sewing lines, according to sewing line matching information,
wherein the sewing line matching information indicates matching of the sewing lines in the different patterns of the piece of the garment.

19. The computing device of claim 18, wherein the processor is further configured to:
responsive to receiving a request to display an exploded view of the piece at the first depth level, display the exploded view of the piece at the first depth level with the different patterns separated from each other by predetermined distances, and
display one or more guide lines extending between the sewing lines of the different patterns to indicate matching of the sewing lines of the different patterns, according to the sewing line matching information.

20. The computing device of claim 18, wherein the selected pattern and one or more adjacent patterns are displayed at enlarged distances at the second depth level, the enlarged distances larger than predetermined distances between the selected pattern and the one or more adjacent patterns at the first depth level.
